(19) United States
(12) Patent Application Publication
(10) Pub. No.: US 2023/0321808 A1
(43) Pub. Date: Oct. 12, 2023

(54) Electric hand-held power tool

(71) Applicant: Hilti Aktiengesellschaft, Schaan (LI)

(72) Inventor: Dominik BUCHNER, Hohenpeissenberg (DE)

(21) Appl. No.: 18/025,245

(22) PCT Filed: Sep. 17, 2021
(86) PCT No.: PCT/EP2021/075685

§ 371 Date: Mar. 8, 2023

(30) Foreign Application Priority Data
Sep. 29, 2020 (EP) 20198937.3

(51) Int. Cl. B25F 1/02; B25F 3/00; B25F 5/02

(52) U.S. Cl. CPC B25F 1/02; B25F 3/00; B25F 5/02

(57) ABSTRACT

Electric hand-held power tool with a housing and a tool fitting, the hand-held power tool having a TOF sensor, which is arranged on the or in the housing and the field of view of which is oriented in the direction of the tool fitting, so that the TOF sensor can detect a tool to be fitted in the tool fitting.

The present invention relates to an electric hand-held power tool with a housing and a tool fitting. Such hand-held power tools, for example in the form of hammer drills or drill drivers, are known in principle from the prior art.

### SUMMARY OF THE INVENTION

An object of the present invention is to provide an electric hand-held power tool that makes comparatively comfortable handling possible.

The present invention provides that the hand-held power tool has a TOF sensor, which is arranged on the or in the housing and the field of view of which is oriented in the direction of the tool fitting, so that the TOF sensor can detect a tool to be fitted in the tool fitting.

The TOF sensor is a 3D camera system, which can measure distances or paths by the time-of-flight method (TOF or ToF). TOF sensors may also be referred to as TOF cameras, PMD sensors or PMD cameras. The PMD sensor or PMT camera is a photonic mixing detector (also known as a photonic mixing device), which is essentially an optical sensor operating on the basis of the time-of-flight method principle.

The invention includes the finding that different tools, for example inserts such as drill bits or the like, can have different effects on power requirements of an electric hand-held power tool. For example, the drilling of a hole with a comparatively large diameter (for example 30 mm) requires considerably more power than the drilling of a comparatively small hole (for example 5 mm). The tool itself may also be differently designed according to its use. Since the tools are typically universally usable, the hand-held power tool does not “know” which tool is fitted at any one time in the tool fitting. It is up to the user to adapt the hand-held power tool individually to the respective tool. The individual adaptation may concern for example the speed, torque, striking rate or similar other operating parameters.

By contrast, the hand-held power tool according to the invention makes it possible for a tool fitted in the tool fitting to be detected by means of a TOF sensor, and thus creates the basis for an automatic, or at least partially automatic, adaptation of the hand-held power tool to the respective tool. This increases both comfort and safety for the user. TOF sensors are typically very robust and tolerant to environmental influences such as light, substrate, etc.

In a particularly preferred embodiment, the hand-held power tool has sensor electronics which are designed to determine at least one tool-specific tool parameter on the basis of a sensor signal obtained by the TOF sensor. It has been found to be advantageous if the at least one tool parameter is a length, shape and/or size of the tool. The tool parameter may also be a type of the drill, for example a “stone drill”, “metal drill” or “wood drill”.

In a particularly preferred embodiment, the hand-held power tool is equipped with control electronics which are designed to adapt one operating parameter on the basis of a control signal obtained by the sensor electronics. In a particularly preferred embodiment, the control signal obtained by the sensor electronics concerns the tool parameter or parameters. It has been found to be advantageous if comparison or reference values of the at least one tool parameter and/or operating parameter are stored in the sensor electronics and/or in the control electronics, preferably in the form of a lookup table.

In a further preferred embodiment, the sensor electronics are designed to determine on the basis of the sensor signal obtained by the TOF sensor a depth of penetration of the tool into a surface to be worked. It has been found to be advantageous if the at least one operating parameter is adapted by the control electronics on the basis of the determined depth of penetration. Thus, for example, if the tool is provided in the form of a drill, a speed may be reduced by 50% (i.e. 50 percent) when the depth of penetration of the drill into the surface to be worked is for example 80% (i.e. 80 percent) of its total length.

In a further preferred embodiment, the sensor electronics are designed to determine an amount of wear of the tool on the basis of a sensor signal obtained by the TOF sensor. The hand-held power tool may have a display for indicating and/or acknowledging the at least one tool-specific operating parameter. It has been found to be advantageous if the display indicates to the user the amount of wear of the tool.

It has been found to be particularly advantageous if the hand-held power tool is operated by a rechargeable battery. In a particularly advantageous embodiment, the housing has a battery locking foot on which or in which the TOF sensor is arranged. In a particularly preferred embodiment, an angle between a central axis of the field of view and an axis of rotation of the tool is at least 30° (i.e. 30 degrees).

In a further preferred embodiment, the tool fitting is designed for holding a rotating and/or striking tool.

The present invention also provides for use of a TOF sensor for detecting a tool fitted in a tool fitting of an electric hand-held power tool, the TOF sensor being comprised by the electric hand-held power tool. The use according to the invention may be developed in a corresponding way by the features described with respect to the hand-held power tool.

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. Specifically:

FIG. 1 shows a first preferred exemplary embodiment of an electric hand-held power tool according to the invention in the form of a hammer drill.

### DETAILED DESCRIPTION

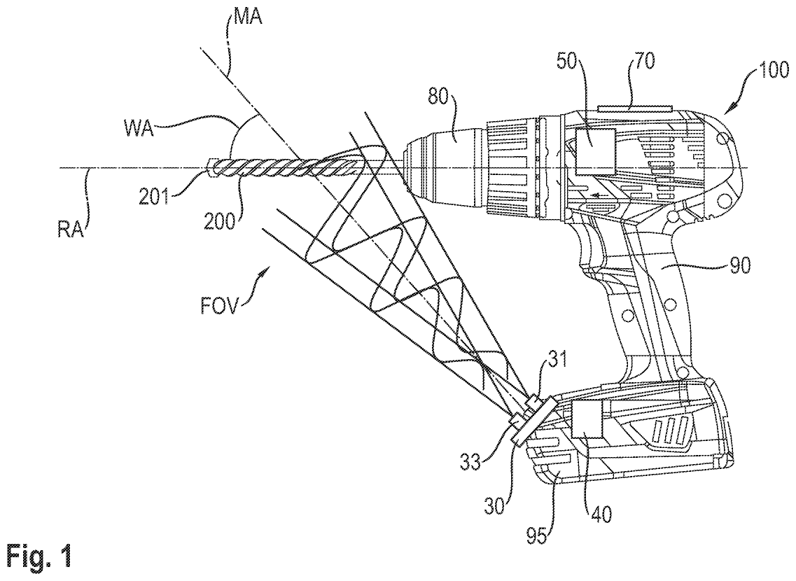

A preferred exemplary embodiment of an electric hand-held power tool 100 is illustrated in FIG. 1. The hand-held power tool 100 is equipped with a housing 90 and a tool fitting 80. In the exemplary embodiment illustrated here, the hand-held power tool 100 is designed as a battery-operated drill driver with a battery locking foot 95. The battery locking foot 95 is understood as being part of the housing 90.

The hand-held power tool 100 has a TOF sensor 30, arranged on the housing 90 in the region of the battery locking foot 95. A field of view FOV of the TOF sensor 30 is in this case oriented in the direction of the tool fitting 80, so that the TOF sensor 30 can detect a tool 200 clamped in the tool fitting 80. The tool fitting 80 is designed for holding a rotating tool 200. The tool 200 is provided by way of example in the form of a drill with an axis of rotation RA.

The TOF sensor 30 emits a modulated infrared light by means of a transmitter array 31. This light is at least partially reflected by the tool 200 and received again by a receiver array 33 of the TOF sensor 30. The measured phase difference between the emitted light and the received light and also the amplitude of the received light are evaluated by sensor electronics 40, which are connected in signaling terms to the TOF sensor 30, and provide very accurate distance information and contours of the tool 200. As a result, the tool 200 can be detected very accurately and reliably, for example in its shape and size. Accordingly, the sensor electronics 80 are comprised by the hand-held power tool 100 and designed to determine at least one tool parameter of the tool 200, in particular its length, shape and/or size, on the basis of a sensor signal obtained by the TOF sensor 30.

As can be seen from FIG. 1, an angle WA between a central axis MA of the field of view FOV and an axis of rotation RA of the tool 200 is approximately 45 degrees, i.e. at least 30 degrees. This does mean that the tool 200 is sensed obliquely or laterally by the TOF sensor 30, which leads to a distorted image of the tool 200. However, this distortion can be “calculated out” by the sensor electronics 40. As can be seen from FIG. 1, this means the angle WA located between a tip 201 of the tool 200 and the axis of rotation RA of the tool 200 on the side of the axis of rotation RA that is facing away from the battery locking foot 95.

In the present exemplary embodiment illustrated, the hand-held power tool 100 also has control electronics 50 which are designed to adapt at least one operating parameter of the hand-held power tool 100 on the basis of a control signal obtained by the sensor electronics 40. This is to be explained in more detail on the basis of an example. The tool 200 is provided in the form of a drill. The drill is sensed by the TOF sensor 30, the TOF sensor 30 being connected in signaling terms to the sensor electronics 40. Reference values for typical drill diameters, lengths, types etc. are in turn stored in a lookup table in the sensor electronics 40. On the basis of the sensor signal obtained by the TOF sensor 30, the sensor electronics 40 can then determine that a stone drill with a length of 150 mm and with a diameter of 10 mm is clamped in the tool fitting 80. A maximum speed of the tool fitting of 1000 rpm may be specified for this drill for example by means of the control electronics 50. This maximum speed is a tool-specific operating parameter.

In the present exemplary embodiment illustrated, the hand-held power tool 100 also has a display 70 for indicating and acknowledging the at least one tool-specific operating parameter. Thus, by way of example, a maximum speed of the tool fitting of 1000 rpm is indicated for the type of drill determined. The user may acknowledge this operating parameter using the display 70, whereupon the control electronics 50 can implement this specification. Alternatively, the user may for example reduce or increase this operating parameter using the display 70, and subsequently acknowledge it.

According to another aspect of the invention, the use of a TOF sensor 30 for detecting a tool 200 fitted in a tool fitting 80 of an electric hand-held power tool 100 is proposed, the TOF sensor 30 being comprised by the electric hand-held power tool 100.

### LIST OF REFERENCE SIGNS

30 TOF sensor (time-of-flight sensor)
31 Transmitter array
33 Receiver array
40 Sensor electronics
50 Control electronics
70 Display
80 Tool fitting
90 Housing
95 Battery locking foot
100 Electric hand-held power tool
200 Tool
201 Tool tip
MA Central axis
FOV Field of view
RA Axis of rotation
WA Angle

1-11. (canceled)

12: An electric hand-held power tool comprising:
a housing;
a tool fitting; and
a TOF sensor arranged on the or in the housing and having a field of view oriented in the direction of the tool fitting so that the TOF sensor can detect a tool to be fitted in the tool fitting.

13: The hand-held power tool as recited in claim 12 further comprising sensor electronics designed to determine at least one tool parameter of the tool on the basis of a sensor signal obtained by the TOF sensor.

14: The hand-held power tool as recited in claim 13 wherein the at least parameter is a length, shape or size.

15: The hand-held power tool as recited in claim 13 further comprising control electronics designed to adapt at least one operating parameter of the hand-held power tool on the basis of a control signal relating to the at least one tool parameter obtained by the sensor electronics.

16: The hand-held power tool as recited in claim 15 wherein comparison or reference values of the at least one tool parameter are stored in the sensor electronics or in the control electronics.

17: The hand-held power tool as recited in claim 16 wherein the comparison or reference values are in the form of a lookup table.

18: The hand-held power tool as recited in claim 13 wherein the sensor electronics are designed to determine an amount of wear of the tool on the basis of a sensor signal obtained by the TOF sensor.

19: The hand-held power tool as recited in claim 13 wherein the sensor electronics are designed to determine on the basis of a sensor signal obtained by the TOF sensor a depth of penetration of the tool into a surface to be worked and to adapt the at least one operating parameter on the basis of the depth of penetration.

20: The hand-held power tool as recited in claim 19 wherein the at least one operating a parameter is a speed.

21: The hand-held power tool as recited in claim 12 further comprising a display for indicating or acknowledging the at least one tool-specific operating parameter.

22: The hand-held power tool as recited in claim 12 wherein the hand-held power tool is battery-operated, the housing having a battery locking foot, the TOF sensor being arranged on or in the battery locking foot.

23: The hand-held power tool as recited in claim 12 wherein an angle between a central axis of the field of view and an axis of rotation of the tool is at least 30 degrees.

24: The hand-held power tool as recited in claim 12 wherein the tool fitting is designed for holding a rotating or striking tool.

25: A method for operating an electric hand-held power tool comprising:
employing a TOF sensor for detecting a tool fitted in a tool fitting of the electric hand-held power tool, the TOF sensor being part of the electric hand-held power tool.
